(19) United States
(12) Patent Application Publication
(10) Pub. No.: US 2014/0131258 A1
(43) Pub. Date: May 15, 2014

(54) METHOD FOR REMOVING OIL

(71) Applicant: Peter Piispanen, Stockholm (SE)

(72) Inventor: Peter Piispanen, Stockholm (SE)

(73) Assignee: ORGANOPETROLEUM PSP AB, Stockholm (SE)

(21) Appl. No.: 14/113,333

(22) PCT Filed: Apr. 25, 2012
(86) PCT No.: PCT/EP12/57514

§ 371 Date: Dec. 13, 2013

Related U.S. Application Data
(60) Provisional application No. 61/478,972, filed on Apr. 26, 2011.

(30) Foreign Application Priority Data
Apr. 26, 2011 (SE) 1150360-4

(51) Int. Cl. C11D 1/66

(52) U.S. Cl. CPC C11D 1/66
USPC 208/390; 564/507; 510/365; 134/40

(57) ABSTRACT

A method for removing oil from a physical object comprises the steps: i) bringing said physical object in contact with an oil removal composition, said oil removal composition comprising a) a surfactant having the general formula: R1-X—R2, wherein R1 is an open chain sugar alcohol, wherein X is one selected from NH, NCH3 and NCH2CH3, and wherein R2 is an aliphatic or aromatic group comprising at least 5 carbon atoms, and b) water, ii) leaving said oil removal composition in contact with said physical object for a period of time sufficient for most of said oil to be dispersed in said oil removal composition, High recovery of oil/bitumen from tar sands can be achieved. The composition is renewable, degradable and inexpensive. An extremely efficient de-greater is provided. The composition used in both bitumen recovery and degreasing is easily reusable and recycleable. The starting materials of the surfactant are renewable and inexpensive. The composition is non-toxic and biodegradable.

### TECHNICAL FIELD

The present invention relates generally to a method for removing oil and an oil removal composition.

### BACKGROUND

In the prior art, the substances including 1-deoxy-1-N-octylamino-D-glucitol are known. The substance is for instance disclosed in Journal of Surfactants and Detergents, Volume 7, No 2, pages 147-159 and pages 161-167.

WO 96/28458 discusses a compound like 1-deoxy-1-N-octylamino-D-glucitol as a biocide for instance within industrial applications such as in hydraulic fluid, cooling liquid.

WO 98/07508 discusses less effective, related compounds like 1-deoxy-1-N-octylamino-D-glucitol as compositions and methods for dispersing and biodegrading spilled oils and fuels.

Removal of oil from physical objects is a problem within many fields. Examples include cleaning after oil spillage, and cleaning, degreasing, and oil recovery from tar sands.

Oil recovery from tar sands is for instance described in Speight, J. G. (2009) Enhanced Recovery Methods for Heavy Oil and Tar Sands, Gulf Publishing Company, Houston.

Many current additives are not renewable and/or are expensive. Further, some of the chemicals used today may be toxic and/or non-biodegradable.

Further, there is room for improvement regarding the emulsification and dispersion capabilities of the substances according to the state of the art.

Many current technologies cause environmental damage due to the fact that they are toxic, non-biodegradable and/or non-reusable.

A more effective, less expensive and non-toxic technology is thus needed for the recovery of tar sands, for oil removal in connection with cleaning including cleaning after oil spillage.

### SUMMARY

It is an object of the present invention to obviate at least some of the disadvantages in the prior art and provide an improved method for removing oil as well as an improved oil removal composition.

In a first aspect there is provided a method for removing oil from a physical object, said method comprising the steps:
i) bringing said physical object in contact with an oil removal composition, said oil removal composition comprising a) a surfactant having the general formula: R1-X—R2;
wherein R1 is an open chain sugar alcohol; wherein X is one selected from NH, NCH₃ and NCH₂CH₃; and wherein R2 is an aliphatic or aromatic group comprising at least 5 carbon atoms; and b) water;
ii) leaving said oil removal composition in contact with said physical object for a period of time sufficient for at least a part of said oil to be dispersed in said oil removal composition.

In a second aspect there is provided use of a composition comprising
a) a surfactant having the general formula: R1-X—R2;
wherein R1 is an open chain sugar alcohol;
wherein X is one selected from NH, NCH₃ and NCH₂CH₃; and
wherein R2 is an aliphatic or aromatic group comprising at least 5 carbon atoms; and
b) water;
   for removing oil from a physical object.

In a third aspect there is provided an oil removal composition comprising
a) a surfactant having the general formula R1-X—R2;
wherein R1 is an open chain sugar alcohol; wherein X is one selected from NH, NCH₃ and NCH₂CH₃; and wherein R2 is an aliphatic or aromatic group comprising at least 5 carbon atoms; and
b) water.

In a fourth aspect, there is provided a surfactant selected from 1-deoxy-1-octyl-(2-)amino-D-glucitol; 1-deoxy-1-octyl-(3-)amino-D-glucitol; and 1-deoxy-1-(4-trans-)octenylamino-D-glucitol.

Further aspects and embodiments are defined in the appended claims, which are specifically incorporated herein by reference.

There is provided new, natural product-based substances.

High recovery of oil/bitumen from tar sands can be achieved.

The method and composition function well under heat, pressure, high salinity and high water hardness. The composition is renewable, degradable and inexpensive.

Another advantage is that an extremely efficient degreaser is provided. Oily metal surfaces (for example, alumina and steel) can be degreased in a short time.

The starting materials of the surfactant are inexpensive and at least partly renewable.

The composition is non-toxic and biodegradable.

### BRIEF DESCRIPTION OF THE DRAWINGS

The invention is now described, by way of example, with reference to the accompanying drawings, in which:

FIG. 1a shows the chemical structure of 1-deoxy-i-octylamino-D-glucitol. Alternatively, the structure may be named N-octyl-D-glucamine.

FIG. 1 b shows the chemical structure of 1-deoxy-i-octyl-(2-)amino-D-glucitol. Alternatively, the structure may be named N-(1-methylheptyl)-D-glucamine or N-(2-octyl)-D-glucamine.

FIG. 1c shows the chemical structure of 1-deoxy-i-octyl-(3-)amino-D-glucitol. Alternatively, the structure may be named N-(1-ethylhexyl)-D-glucamine or N-(3-octyl)-D-glucamine.

FIG. 1d shows the chemical structure of 1-deoxy-1-benzylamino-D-glucitol. Alternatively, the structure may be named N-benzyl-D-glucamine.

FIG. 1e shows the chemical structure of 1-deoxy-1-dodecylamino-D-glucitol. Alternatively, the structure may be named N-dodecyl-D-glucamine.

FIG. 1f shows the chemical structure of 1-deoxy-1-(4-trans-)octenylamino-D-glucitol. Alternatively, the structure may be named N-oct-4-trans-enyl-D-glucamine.

### DETAILED DESCRIPTION

Before the invention is disclosed and described in detail, it is to be understood that this invention is not limited to particular compounds, configurations, method steps, physical objects, and materials disclosed herein as such compounds, configurations, method steps, physical objects, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “about” as used in connection with a numerical value throughout the description and the claims denotes an interval of accuracy, familiar and acceptable to a person skilled in the art. Said interval is ±10%.

“Hydrocarbon” is used herein to denote an organic compound comprising hydrogen and carbon.

“Oil” is used herein in a wide sense to denote hydrophobic compounds including hydrocarbons found in for instance crude oil and petroleum. Oil includes mixtures comprising oil such as grease. Oil further encompasses hydrophobic mixtures of dirt. Oil includes both compounds which are liquid, plastic, or soft solid at room temperature (20° C.).

“Sugar alcohol” is used herein to denote a hydrogenated form of a carbohydrate whose carbonyl group has been reduced to a primary or secondary hydroxyl group. An open chain sugar alcohol refers to a sugar alcohol which is not cyclic.

“Tar sand” is used to denote naturally occurring mixtures of sand, clay, water and a highly viscous petroleum (or bitumen). Bituminous sand and oil sand may also be used to denote tar sand. Tar sand may be of the type carbohydrate-wet tar sand or the type water-wet tar sand.

In a first aspect there is provided a method for removing oil from a physical object, said method comprising the steps:

i) bringing said physical object in contact with an oil removal composition, said oil removal composition comprising
a) a surfactant having the general formula R1-X—R2;
wherein R1 is an open chain sugar alcohol; wherein X is one selected from NH, NCH₃ and NCH₂CH₃; and
wherein R2 is an aliphatic or aromatic group comprising at least 5 carbon atoms; and
b) water;
ii) leaving said oil removal composition in contact with said physical object for a period of time sufficient for at least a part of said oil to be dispersed in said oil removal composition.

In one embodiment of this aspect, the connecting bond between R1 and R2 consists of an amine bond. In one embodiment the surfactant is a secondary amine. The free rotation ability of the bond (—NH—, —NCH₃—, —NCH₂CH₃—), in contrast with for example ester and amide bonds, combined with the hydrogen bonding property of the amino bond, ensures potentially effective micellar packing. The choice of using one of the above bonds, in contrast to an ester or amide bond, also makes the molecule exceptionally stable towards hydrolysis, as well as reasonably stable against heat degradation.

In one embodiment of this aspect, the physical object is tar sand. By removing the oil from the tar sand the oil can be extracted for subsequent use. In embodiments where oil is extracted from tar sand, the oil in the composition is separated from the composition at least to some extent and the composition is preferably re-used.

In one embodiment of this aspect, the physical object is made of metal. Examples of metal include but are not limited to iron, steel, brass, aluminium, copper, and silver. Metals include both elemental metal and metal alloys. In one embodiment the physical object is selected from the group consisting of a car, a truck, a trailer, a bus, a train, and a locomotive. Thus the method may be used for cleaning of a physical object, in particular where the dirt comprises many hydrophobic compounds and/or oil.

In one embodiment of this aspect, the physical object is an object in nature. Examples of such objects include but are not limited to leaves, herbs, rocks, stones, sand, bushes, and trees. In one embodiment the physical object is a plant.

In one embodiment of this aspect, the oil removal composition is reused. In one embodiment the oil-containing removal composition is reused in further extraction processes.

In one embodiment of this aspect, the pH of said oil removal composition is adjusted before said oil removal composition is contacted with said physical object. In one embodiment the pH of said oil removal composition is adjusted when said oil removal composition is in contact with said physical object. In one embodiment the pH of the oil removal composition is adjusted both before said oil removal composition is contacted with said physical object and when said oil removal composition is in contact with said physical object. In an embodiment where the oil removal composition is recycled and reused, a rarely found surfactant property among recovery technologies, the pH of the composition is preferably monitored and adjusted if needed.

In one embodiment of this aspect, the pH of said oil removal composition is adjusted to a value above 8. In one embodiment the pH of said oil removal composition is adjusted to a value above 8.5. In one embodiment the pH of said oil removal composition is adjusted to a value above 9. In one embodiment the pH of said oil removal composition is adjusted to a value above 9.5. In one embodiment the pH of said oil removal composition is adjusted to about the pKa-value of the surfactant (which is 9.8 for 1-deoxy-1-octylamino-D-glucitol), for optimal recovery. In one embodiment the pH of said oil removal composition is adjusted to a value within the range of 8 to 11.5. In one embodiment the pH is adjusted by addition of a base. Examples of bases include but are not limited to lithium hydroxide, sodium hydroxide and sodium bicarbonate. The pH above 8 gives a non-protonated, active surfactant. Buffering with a base is advantageous in many cases since it enables the high pH levels required for the non-protonated amine moiety, and thus high and optimal recovery effect.

The basic amine bond helps keeping the pH of the surfactant solution high (above neutral), which keeps the concentration of hydroxide ions high and available for reaction with the acidic parts of the oil component, thus producing further surface active compounds from the oil itself.

In one embodiment of this aspect, the temperature is about 25° C. In one embodiment of this aspect, the temperature is from about 50° C. to about 100° C. In one embodiment of this aspect, the temperature is from about 60° C. to about 100° C. The temperature should preferably not exceed the boiling point of the oil removal composition. When calculating the boiling point the pressure must also be regarded. Water is used as solvent and if the pressure is higher than atmospheric pressure, the temperature may also exceed 100° C. It is an advantage that no organic solvents are used and that water is used as solvent. Within this embodiment, the method may further comprise a step iii): including adding an insoluble, organic solvent to said oil removal composition in contact with said physical object. Further, it would be possible to recover said oil from an upper organic phase.

In one embodiment of this aspect, the physical object is rinsed with a solvent after being in contact with said oil removal composition. In one embodiment the steps of bringing said physical object in contact with said oil removal composition and rinsing are performed subsequently and are repeated. An enhanced cleaning effect is achieved if the composition repeatedly is contacted with the object with rinsing in between. An embodiment with rinsing in between also saves surfactant, which will give a more economical process. In one embodiment the oil removal composition is recycled and reused.

In one embodiment of this aspect, the solvent is water. Water is advantageous from an environmental point of view. Water is also economical.

In one embodiment of this aspect, the concentration of said surfactant in said solvent is at least 0.06 w/v %. In another embodiment of this aspect, the concentration of said surfactant in said solvent is about 0.5 w/v %. The concentration is calculated as weight of the surfactant per volume of the solvent mixture after mixing. Dilute surfactant solutions such as down to 0.06 w/v % will also function although this may prolong the reaction time needed. In an embodiment where the physical object is tar sand a large volume is advantageous in some embodiments, since it is easier to cover all tar sand.

In one embodiment of this aspect, R1 is selected from the group consisting of mannitol, sorbitol, galactitol, iditol, allitol, altriol, gulitol and talitol.

In one embodiment of this aspect, R1 is sorbitol.

In one embodiment of this aspect, R1 is further modified with at least one entity consisting of a sugar group of up to around ten sugar moieties, which increases the aqueous solubility of the surfactant.

In one embodiment of this aspect, R2 is unbranched. In one embodiment of this aspect, R2 is branched. In one embodiment of this aspect, R2 is saturated. In one embodiment of this aspect, R2 is unsaturated. In one embodiment of this aspect, R2 comprises 5-13 carbon atoms. In one embodiment of this aspect, R2 comprises 5-12 carbon atoms. In one embodiment of this aspect, R2 comprises 7-13 carbon atoms. In one embodiment of this aspect, R2 comprises 8-12 carbon atoms. In one embodiment of this aspect, R2 comprises 8 carbon atoms.

In one embodiment of this aspect, said surfactant said surfactant is selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol;1-deoxy-1-dodecylamino-D-glucitol; and 1-deoxy-1-(4-trans-)octenylamino-D-glucitol.

In one embodiment of this aspect, said surfactant said surfactant is 1-deoxy-1-octylamino-D-glucitol.

In a second aspect there is provided use of a composition comprising
a) a surfactant having the general formula: R1-X—R2;
wherein R1 is an open chain sugar alcohol,
wherein X is one selected from NH, NCH₃ and NCH₂CH₃, and
wherein R2 is an aliphatic or aromatic group comprising at least 5 carbon atoms; and
b) water;
   for removing oil from a physical object.

In one embodiment of this aspect, R1 is selected from the group consisting of mannitol, sorbitol, galactitol, iditol, allitol, altriol, gulitol and talitol.

In one embodiment of this aspect, R1 is sorbitol.

In one embodiment of this aspect, R1 is further modified with at least one entity consisting of a sugar group of up to around ten sugar moieties, which increases the aqueous solubility of the surfactant.

In one embodiment of this aspect, R2 is unbranched. In one embodiment of this aspect, R2 is branched. In one embodiment of this aspect, R2 is saturated. In one embodiment of this aspect, R2 is unsaturated. In one embodiment of this aspect, R2 comprises 5-13 carbon atoms. In one embodiment of this aspect, R2 comprises 5-12 carbon atoms. In one embodiment of this aspect, R2 comprises 7-13 carbon atoms. In one embodiment of this aspect, R2 comprises 8-12 carbon atoms. In one embodiment of this aspect, R2 comprises 8 carbon atoms.

In one embodiment of this aspect, said solvent is water.

In one embodiment of this aspect, said surfactant is selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol;1-deoxy-1-dodecylamino-D-glucitol; and 1-deoxy-1-(4-trans-)octenylamino-D-glucitol.

In one embodiment of this aspect, said surfactant is 1-deoxy-1-octylamino-D-glucitol

In a third aspect there is provided an oil removal composition comprising
a) a surfactant having the general formula R1-X—R2;
   wherein R1 is an open chain sugar alcohol; wherein X is one selected from NH, NCH₃ and NCH₂CH₃; and
   wherein R2 is an aliphatic or aromatic group comprising at least 5 carbon atoms; and
b) a solvent.

In one embodiment of this aspect, R1 is selected from the group consisting of mannitol, sorbitol, galactitol, iditol, allitol, altriol, gulitol and talitol. In one embodiment wherein R1 is sorbitol.

In one embodiment of this aspect, R1 is further modified with at least one entity consisting of a sugar group, of up to around ten sugar moieties, which increases the aqueous solubility of the surfactant.

For R1, other monosaccarides will also function well as will slightly modified sugars and di-, tri-. etc. sugars that do not disturb micellar packing, i.e. the sugar alcohol should be open chain.

In one embodiment of this aspect, R2 is unbranched. In an alternative embodiment R2 is branched. The molecular structure is preferably linear to avoid micellar curvature and enable dense packing.

In one embodiment of this aspect, R2 is saturated. In an alternative embodiment R2 is unsaturated.

In one embodiment of this aspect, R2 is unbranched. In one embodiment of this aspect, R2 is branched. In one embodiment of this aspect, R2 is saturated. In one embodiment of this aspect, R2 is unsaturated. In one embodiment of this aspect, R2 comprises 5-13 carbon atoms. In one embodiment of this aspect, R2 comprises 5-12 carbon atoms. In one embodiment of this aspect, R2 comprises 7-13 carbon atoms. In one embodiment of this aspect, R2 comprises 8-12 carbon atoms. In one embodiment of this aspect, R2 comprises 8 carbon atoms.

In one embodiment of this aspect, R1 is selected from the group consisting of mannitol, sorbitol, galactitol, iditol, allitol, altriol, gulitol and talitol.

In one embodiment of this aspect, R1 is sorbitol.

In one embodiment of this aspect, R1 is further modified with at least one entity consisting of a sugar group of up to around ten sugar moieties, which increases the aqueous solubility of the surfactant.

In one embodiment of this aspect, said composition comprises a surfactant selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol;1-deoxy-1-dodecylamino-D-glucitol; and 1-deoxy-1-(4-trans-) octenylamino-D-glucitol; and water.

In one embodiment of this aspect, said composition comprises a surfactant selected from 1-deoxy-1-octyl-(2-)amino-D-glucitol; 1-deoxy-1-octyl-(3-) amino-D-glucitol; and 1-deoxy-1-(4-trans-)octenylamino-D-glucitol; and water.

In a fourth aspect, there is provided a surfactant selected from 1-deoxy-1-octyl-(2-)amino-D-glucitol; 1-deoxy-1-octyl-(3-)amino-D-glucitol; and 1-deoxy-1-(4-trans-)octenylamino-D-glucitol.

Without wishing to be bound by any particular scientific theories the inventor believes that the surfactant has its considerable surface activity due to its very effective packing. The ability of the connecting bond (the amine moiety) to form hydrogen bonds with the structurally similar amides, but not esters, do, may be essential for effective packing. The surfactant is capable of lowering aqueous surface tension down to about an amazing 20 dynes/cm. This strongly reduced surface tension makes for a very good emulsifier of oil.

The molecular structure of the surfactant is preferably linear to avoid excessive micellar curvature and enable dense packing. This is facilitated by both the open sugar and the amine connecting bond, unique to this invention.

The presence of the amine connecting bond in the surfactant presents the rare opportunity to reuse the surfactant solution, after either bitumen recovery from tar sand or after use as a cleaning agent or degreaser. Any and all formed emulsions—unlike surfactants with ester, ether and amide connecting bonds—can be separated from the solution by acidification, followed by decanting of the upper oil phase. Addition of base regenerates the surfactant, which is completely clear from oil, and thus can be reused. Also, the surfactant solution has proven extremely effective when reused with the same application even without the de-oiling step.

Other features and uses of the invention and their associated advantages will be evident to a person skilled in the art upon reading the description and the examples.

It is to be understood that this invention is not limited to the particular embodiments shown here. The following examples are provided for illustrative purposes and are not intended to limit the scope of the invention since the scope of the present invention is limited only by the appended claims and equivalents thereof.

### EXAMPLES

### Example 1, recovery of oil from tar sands

Into a steel container of at least 250 mL and equipped with a magnetic stirrer was poured a water solution of 1-deoxy-1-octylamino-D-glucitol (100 mL; stock solution of 0.5 w/v-%; pH about 8.2). The solution was heated to +77° C. with stirring after which tar sand (50 gram; API oil gravity of 8) is added.

Contents of the tar sands used in all experiments: Supplier: Kentucky, USA Sampled date: 2010Nov. 29. Analysis of the used tar sands is summarized in the table below:

| Analysis | Result |
|---|---|
| Composition | Tarry, thick sand-like |
| Color | Black |
| Oil component: API oil | 8 |
| gravity | |
| Wetness | Carbohydrate wet |
| Density | >871 g/dm³ |
| Maximum oil content | At most 17 w/w-% |

Stirring was increased to 900 rpm to ensure that localized clumps of tar sand do not form at the bottom of the container (the pH almost immediately falls down to about 7.2 or lower due to reactions with acidic oily components). The pH of the solution was increased to 10.4 by addition of a base (LiOH (s); 50 mg) upon which solution turns greyish. The recovery process was allowed for 30 minutes after which heating was turned off. During this process, all oily components were peeled off from the tar sand (part going to form emulsions) after which the thick oily compounds clumped together separated from the sand. Once the mixture had cooled down to +40° C. and particles had settled down the black surfactant solution was decanted off and saved. The remains in the container—the sand and clumps of oil—were briefly washed with water, which was added to the saved surfactant solution. The contents were left to dry. When the contents were dry, everything was filtered through a fine steel mesh, which separated the fine sand from clumps of the desired bitumen. 8.5 grams of bitumen containing some water and sand was recovered. (100 g of this tar sand comprises up to a maximum content of 17 w-% bitumen; the obtained yield is thus quantitative).

The method as described above also works in very saline (sodium chloride) and/or very hard water (calcium and magnesium ions) if the pH is increased to 11.5 to recover at >90% of the bitumen in the tar sand. In comparison, a technical mixture of ethoxylated sorbitol oleates, as presented in WO98/08/07508, being sensitive to saline conditions, yielded less than 90% recovery of bitumen under such conditions, but more than pure water (about 70%).

The method as described above can also be practically performed at room temperature (25 degrees centigrade), to save energy on heating, if for example the recovery is done for up to one day with an added, upper phase of an insoluble, organic solvent such as toluene (50 mL). In that case, the bitumen will almost quantitatively be found in the upper, organic phase and can be decanted off, after which the surfactant composition can be reused.

The process also works well with other tar sands, such as that present in Utah and Canada, as long as a sufficient amount of base is added to ensure an optimal working pH.

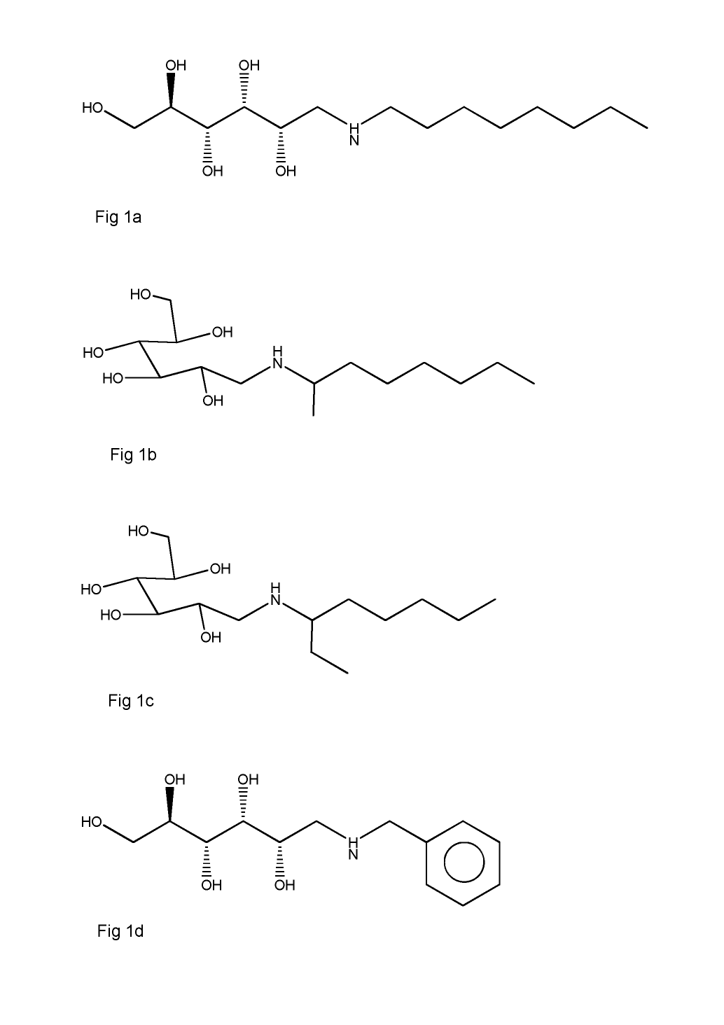

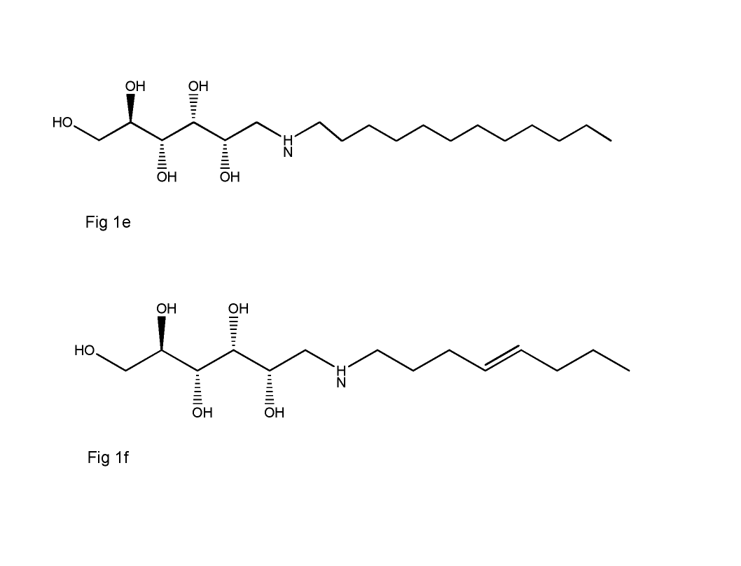

The process also works well with structural derivatives of the surfactant, such as 1-deoxy-1-octyl-(2-)amino-D-glucitol (FIG. 1b), 1-deoxy-1-octyl-(3-)amino-D-glucitol (FIG. 1c), 1-deoxy-1-benzylamino-D-glucitol (FIG. 1d), 1-deoxy-1-dodecylamino-D-glucitol (FIGS. 1e) and 1-deoxy-1-(4-trans-)octenylamino-D-glucitol (FIG. 1f), all yielding comparative recovery results (>90% recovered bitumen). Pure water, in comparison, which is today commonly used in the recovery of bitumen from tar sand in Canada, can give up to at most 70 recovered bitumen.

### Example 2

### Metal Degreasing

A vehicle metal door, heavily greased through regular traffic for many months was sprayed a couple of times with the surfactant solution (0.5 w/v-%). Within the minute, a paper towel was used to swipe through the greasy layers, leaving behind a well-cleaned, shiny surface. In comparison, common and even expensive regularly used cleaning agents, were shown to be less effective.

### Example 3

### Metal Degreasing

Into a steel spoon (approx. 6.5×3.5 cm) was poured thick crude oil (c:a 0.3 g), after which surfactant solution (c:a 3 mL; 0.5 w/v-%) was poured in. The oil was almost immediately shaved off the metal surfaces and floated at the edges of the clear solution; the shiny bottom was clearly visible and the solution with the oil was easily discarded. A similar experiment with pure water had no effect whatsoever on oil removal, and left a black spoon bottom. The structural derivatives given in FIG. 1b-1f also gave very similar degreasing results. In similar tests, using commercial cleaning agents, much more surfactant was required for effective degreasing, or then the commercial surfactant completely failed to degrease the oil.

### Example 4

### Metal Degreasing

An aluminium spoon (approx. 6.5×3.5 cm) was filled with thick crude oil (5.02 g) and the surfactant solution was added (5.75 mL; 0.5 w/v-%) and left to shave off the oil. After one minute the contents were poured out, which had removed most of the oil, leaving some (0.562 g oil remaining). More surfactant solution was added (4.25 mL; 0.5 w/v-%) and left to degrease for one minute, after which the contents were poured out, leaving behind a small oily film (0.183 g). Noteworthy is that these are the results with no mechanical effect whatsoever; the remaining oil was very easily and quantitatively removed with a paper towel. As a comparison pure water could do little to facilitate the removal of said oil. In stark contrast to the ethoxylated sorbitol oleates presented in WO 98/07508, as well as commercial polyethoxylated alkyl esters and amides, the cleaning surfactant solution can be directly reused as is, or, depending on the cleaned oil, be completely de-oiled by acidification and decanting followed by the addition of base to reach the working pH-range, which produces a fully regenerated, and active cleaning surfactant solution. Reusing the cleaning solution makes for reduced costs and a feasible product.

### Example 5

### Plant Washing

Two leaves were dipped in thick crude oil and hung up to drip off excess oil and dry. One leaf was rigorously washed by spraying it with water, although this had little effect. The other leaf was washed by the surfactant solution (0.5 w/v-%) where one could see the oil being peeled off. The surfactant washing could be made even more effective by intermediary washes with a solution of lithium hydroxide (0.05 w/v-%); this stabilized the emulsification ability of the surfactant. In the end, after equal amounts of washing, only the leaf washed with surfactant solution was completely washed and degreased, as determinable by the naked eye. Given that the surfactant is non-toxic and biodegradable the application can be performed out in nature, which is likely not practical with ethoxylated surfactants which are known to be relatively toxic to aquatic life.

### Example 6

### Other Biological Materials

In comparison, few if any commercial surfactants were capable of cleaning biological materials as effectively as the surfactants (FIG. 1a-1f). Workers of Greenpeace are reported to clean one duck drenched in oil in 45 minutes with three persons using commercial surfactants—in contrast, this technology has been tested to clean both feathers and skin in only a matter of minutes.

1. A method for removing oil from a physical object, said method comprising the steps:
i) bringing said physical object in contact with an oil removal composition, said oil removal composition comprising
a) a surfactant having the general formula R1-X—R2;
wherein R1 is an open chain sugar alcohol;
wherein X is one selected from NH, NCH₃ and NCH₂CH₃; and
wherein R2 is an aliphatic or aromatic group comprising at least 5 carbon atoms; and
b) water;
ii) leaving said oil removal composition in contact with said physical object for a period of time sufficient for at least a part of said oil to be dispersed in said oil removal composition.

2. The method according to claim 1, wherein said physical object is selected from tar sand, a physical object made of metal, an object in nature and a plant.

3-6. (canceled)

7. The method according to claim 1, wherein the pH of said oil removal composition is adjusted before said oil removal composition is contacted with said physical object.

8. The method according to claim 1, wherein the pH of said oil removal composition is adjusted when said oil removal composition is in contact with said physical object.

9. The method according to claim 1, wherein the pH of said oil removal composition is adjusted to a value above 8.

10. (canceled)

11. The method according to claim 1, wherein the temperature is about 25° C.

12. The method according to claim 11, further comprising step iii):
adding an insoluble, organic solvent to said oil removal composition in contact with said physical object.

13. The method according to claim 12, further comprising recovery of said oil from an upper organic phase.

14. The method according to claim 1, wherein the temperature is from about 50° C. to about 100° C.

15-19. (canceled)

20. The method according to claim 1, wherein the concentration of said surfactant in said solvent is at least 0.06 w/v %.

21. The method according to claim 1, wherein R1 is sorbitol.

22. The method according to claim 1, wherein X is NH.

23. The method according to claim 1, wherein R2 is unbranched.

24. The method according to claim 1, wherein R2 is branched.

25. (canceled)

26. (canceled)

27. The method according to claim 1, wherein R2 is aromatic.

28. The method according to claim 1, wherein R2 is non-aromatic.

29. The method according to claim 1, wherein R2 comprises 5-13 carbon atoms.

30-32. (canceled)

33. The method according to claim 1, wherein said surfactant is selected from the group consisting of 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol;1-deoxy-1-dodecylamino-D-glucitol; and 1-deoxy-1-(4-trans-)octenylamino-D-glucitol.

34-51. (canceled)

52. An oil removal composition comprising a surfactant selected from the group consisting of 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol; and water.

53. (canceled)

54. A surfactant selected from the group consisting of 1-deoxy-1-octyl-(2-)amino-D-glucitol; 1-deoxy-1-octyl-(3-)amino-D-glucitol; and 1-deoxy-1-(4-trans-)octenylamino-D-glucitol.
